(19) United States
(12) Patent Application Publication
(10) Pub. No.: US 2026/0030224 A1
(43) Pub. Date: Jan. 29, 2026

(54) SYSTEM AND METHOD FOR DECODING VEHICLE IDENTIFICATION NUMBERS (VINS) OF RECREATIONAL VEHICLES (RVS)

(71) Applicant: AMDIA SOFTWARE, LLC, Overland Park, KS (US)

(72) Inventor: Steve C. Francis, Overland Park, KS (US)

(21) Appl. No.: 19/279,364

(22) Filed: Jul. 24, 2025

Related U.S. Application Data
(60) Provisional application No. 63/674,848, filed on Jul. 24, 2024.

(51) Int. Cl. G06F 16/215; G06F 16/248

(52) U.S. Cl. CPC G06F 16/215; G06F 16/248

(57) ABSTRACT

A system and computer-implemented method for storing, retrieving, updating, and scoring reliability of data associated with recreational vehicles (RV). The computer-implemented method includes receiving a vehicle identification number (VIN) of the RV or vehicle, looking up data associated with the VIN in a database, and calculating a reliability score based on the VIN and/or the data associated with the VIN based on a set of standards used for the VIN for RVs or one or more predetermined rules. The computer-implemented method may also include sending instructions to a remote user device to display the data associated with the VIN and the reliability score. The computer-implemented method may also include receiving from the remote user device updates or corrections to the data associated with the VIN or updates to the VIN itself and storing the updates or corrections in the database for future retrieval.

### CROSS-REFERENCE TO RELATED APPLICATIONS

The current patent application is a non-provisional utility patent application which claims priority benefit, with regard to all common subject matter, of earlier-filed U.S. Provisional Application Ser. No. 63/674,848; titled “SYSTEM AND METHOD FOR DECODING VEHICLE IDENTIFICATION NUMBERS (VINS) OF RECREATIONAL VEHICLES (RVS)”; and filed Jul. 24, 2024. The Provisional Application is hereby incorporated by reference herein in its entirety.

### BACKGROUND OF THE INVENTION

The recreational vehicle (RV) industry frequently witnesses potential buyers, insurers, lenders, dealers and web platform providers grappling with the challenges and ambiguities of decoding RV vehicle identification numbers (VINs). In the RV industry, the demand for a reliable and accurate VIN decoding solution is escalating as inconsistencies and misinformation prevail in the current landscape. Many existing offerings in the market often fall short, unable to achieve the required levels of accuracy and inflicting continuous hurdles for various industry stakeholders like banks, insurance companies, dealers, and RV enthusiasts.

Thus there is a need for a system and method that overcomes theses and other deficiencies of the prior art.

### SUMMARY OF THE INVENTION

Embodiments of the current invention address one or more of the above-mentioned problems and provide a distinct advance in the art of recreational vehicles (RVs). Specifically, the present invention provides a VIN RV system and computer-implemented method for vehicle identification numbers (VINs) of recreational vehicles (RVs).

In one example embodiment, a VIN system includes one or more memory devices having a database and one or more processors communicably coupled with the one or more memory devices. The processor may be programmed to perform the following steps: receiving a VIN, retrieving data associated with the VIN in the database, calculating a reliability score based on at least one of the VIN and the data associated with the VIN based on a set of standards used for the VIN for a particular type of vehicle or one or more predetermined rules, and sending instructions to a remote user device to display the data associated with the VIN and the reliability score.

In other exemplary embodiments, a computer-implemented method for storing, retrieving, updating, and scoring reliability of data associated with RVs includes the steps of receiving a VIN, looking up or retrieving data associated with the VIN in a database, calculating a reliability score based on at least one of the VIN and the data associated with the VIN based on a set of standards used for the VIN for RVs or one or more predetermined rules, and sending instructions to a remote user device to display the data associated with the VIN and the reliability score.

In some embodiments, a method may be stored on a non-transitory computer-readable medium, and when executed by one or more processors, may cause the one or more processors to perform any of the following operations, such as storing, retrieving, updating, and scoring reliability of data associated with RVs. For example, the stored instructions on the non-transitory computer-readable medium may cause the processors to: receive a vehicle identification number (VIN) of the RV or vehicle, look up or retrieve data associated with the VIN in a database, calculate a reliability score based on the VIN and/or the data associated with the VIN based on a set of standards used for the VIN for RVs or one or more predetermined rules, and send instructions to a remote user device to display the data associated with the VIN and the reliability score. The stored instructions on the non-transitory computer-readable medium may cause the processors to: receive from the remote user device updates or corrections to the data associated with the VIN or updates to the VIN itself and store the updates or corrections in the database.

The VIN RV system, using comprehensive and precise specification sheets, offers a solution to the RV VIN decoding process, thus playing a crucial role in facilitating informed decision-making across the industry. In some embodiments, the VIN RV system may include a software tool devised to streamline the process of decoding VINs for the RV industry using an AI-powered, user-friendly tool that accurately identifies essential RV specifications such as year, manufacturer, model, trim, weights, measurements and floor plans through a vehicle identification number, fostering a more transparent and efficient process.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the current invention will be apparent from the following detailed description of the embodiments and the accompanying drawing figures.

### BRIEF DESCRIPTION OF DRAWINGS

Embodiments of the current invention are described in detail below with reference to the attached drawing figures, wherein:

FIG. 1 is a block diagram depicting a vehicle identification number (VIN) recreational vehicle (RV) system in accordance with one or more embodiments herein;

FIG. 2 is a table of exemplary data that can be stored in a database of the VIN RV system of FIG. 1 in accordance with one or more embodiments herein;

FIG. 3 is an exemplary screen shot of a web application of the VIN RV system of FIG. 1 depicting a search bar in accordance with one or more embodiments herein;

FIG. 4 is an exemplary screen shot of the web application of the VIN RV system of FIG. 1 depicting a status bar in accordance with one or more embodiments herein;

FIG. 5 is an exemplary screen shot of the web application of the VIN RV system of FIG. 1 depicting a reliability score and RV data in accordance with one or more embodiments herein;

FIG. 6 is an exemplary screen shot of the web application of the VIN RV system of FIG. 1 depicting RV specifications in accordance with one or more embodiments herein;

FIG. 7 is an exemplary operational flow chart of the VIN RV system of FIG. 1 depicting operations of an API, web application, and AI scoring model in accordance with one or more embodiments herein; and

FIG. 8 is a flow chart of a method of storing, retrieving, updating, and/or scoring reliability of data associated with RVs in accordance with one or more embodiments herein.

The drawing figures do not limit the current invention to the specific embodiments disclosed and described herein. The drawings are not necessarily to scale, emphasis instead being placed upon clearly illustrating the principles of the invention.

### DETAILED DESCRIPTION OF THE INVENTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the current invention. The following detailed description is, therefore, not to be taken in a limiting sense. The scope of the current invention is defined only by the appended claims, along with the full scope of equivalents to which such claims are entitled.

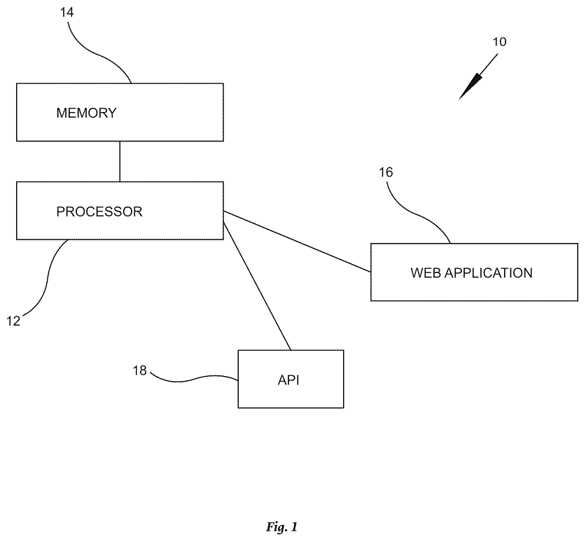

In one or more embodiments herein, a VIN RV system and method for vehicle identification numbers (VINs) of recreational vehicles (RVs) is disclosed. The VIN RV system 10, as depicted in FIG. 1, comprises one or more processors 12 or processing devices and memory 14 accessible via the processors 12 or processing device. In one or more embodiments, the VIN RV system provides a user-friendly front-end web application 16 for quick access to a comprehensive list of specifications corresponding to an input VIN. Beyond serving individual consumers, the VIN RV system may utilize robust Application Programming Interfaces (APIs) 18 or API-like services designed and configured to streamline operations for businesses like banks, insurance companies, and RV dealers. These APIs may facilitate seamless integration of VIN decoding into existing processes, elevating the accuracy of data acquired and enhancing customer satisfaction.

The processor 12 may include one or more processors or processing elements as later described herein (e.g., a computer, server, or the like). The processor 12 may be communicably coupled with the memory 14 via wired or wireless communication components known in the art. Furthermore, the processor 12 may be configured for performing any one or more of the method steps or processes described herein in the sequences described herein or in other sequences without departing from the scope of the technology herein. In some embodiments, any method steps described herein may be omitted without departing from the scope of the technology herein. The processor 12 may also be communicably coupled with third party devices, such as a remote user device (e.g., a computer, phone, tablet, or other electronic device operated by a third party, such as a user requesting information regarding a VIN).

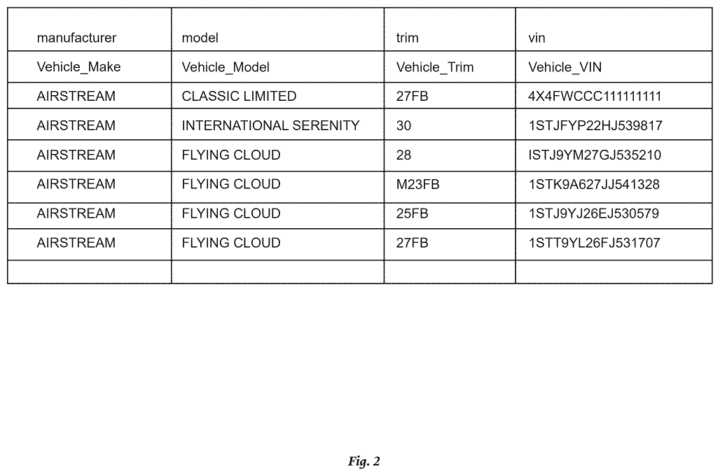

The memory 14 may comprise one or more memory devices storing one or more databases thereon, in addition to computer code for performing one or more of the methods, steps, or processes described herein. For example, the databases may include a rich and continual database, forming the cornerstone of a the high-precision VIN decoding service. In some example embodiments, the database may be housed within a MySQL/MariaDB infrastructure. MySQL and MariaDB are both relational databases that organize data into tables and use Structured Query Language (SQL) to manage and query data. Other relational databases can be used without departing from the scope of the technology described herein. Within this database, each row may contain a ‘VIN’ column that forms a central reference point to link to information including a year, make, model, trim, and specifications for each unique RV model. This database functions as a repository of comprehensive data and is continually updated with user inputs to foster an ever-evolving and improved dataset. An example table of data is depicted in FIG. 2. In one or more embodiments, the one or more databases described above may include a Recreational Vehicle Data System (RDS) including data such as weight, dimensions, axles, capacity, standard features, floorplan images, stock photos, and/or unique AI-generated summaries for each RV. The RDS can, for example, store and provide intricate floor plans for visualizing each RV unit's distinct design and functionality.

The memory may also comprise one or more computer programs, software code, and/or Application Programming Interfaces (APIs). For example, the API may be configured to allow institutions and other businesses to easily integrate data from the databases described above into their systems. When a VIN is sent via an API request, the processor and/or memory described herein can be configured to respond with detailed information including the year, make, model, trim, and other specification data via the API, as well as a reliability score for the data provided for that VIN. Using this data, the API can advantageously be used for aiding in generating insurance quotes, loan offers, web search optimization and more.

To create the reliability scores described herein, the VIN RV system can be configured or otherwise programmed to employ various rules, algorithms, and/or artificial intelligence (AI) data to scrutinize and score the accuracy of the data being sent to the end-users (such as vial the API's described above). The reliability score serves as a representation the VIN RV system's confidence in the accuracy of the data based on the given VIN. Higher scores indicate a higher confidence in the dataset and further enable users to make informed decisions. Lower reliability scores indicate a larger number and/or greater severity of errors. The VIN RV system can be configured or programmed (e.g., with AI algorithms) to meticulously examine each VIN in a dataset and then flag and assign scores based on the VIN's adherence to a set of standards. Each deviation deducts points from the reliability score to provide a graded assessment of data accuracy. For example, if a dataset contains a slightly incorrect VIN, this may trigger a warning or substantially lower a reliability score. In one example embodiment, a standardized VIN structure, which is a 17-character string, excludes the letters I, O, and Q to avoid confusion with numbers. The VIN RV system may be configured such that any deviation from this standard (e.g., an incorrect length or the inclusion of excluded letters) triggers an immediate warning to the requesting user (e.g., via the API), indicating a possible error, or otherwise significantly decreases the reliability score below a predetermined warning threshold. Although the VIN RV system is described herein as being configured to provide reliability scores based on VIN number standards, other standards regarding the accuracy of other data corresponding to the VIN number in the databases herein can also be used to provide reliability scores without departing from the scope of the invention. For example, valuation data can be given a lower reliability score based on user feedback or how much time has passed since the valuation data has been updated (e.g., a valuation from several years ago may be less accurate than a valuation from several days ago). The reliability score described herein may be represented as a numerical score, a percentage, a letter grade (e.g., A, B, C, D, or F), descriptive words or phrases (e.g., “good reliability,” or “bad reliability”), graphics (e.g., a reliability bar graph), colors (e.g., red, yellow, or green), and/or any visual depiction known in the art for indicating varying degrees of something (e.g., degree of reliability).

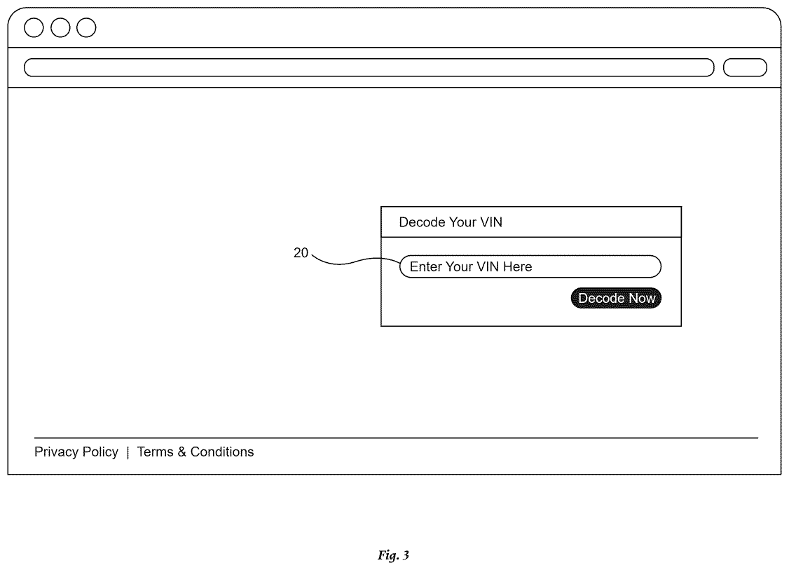

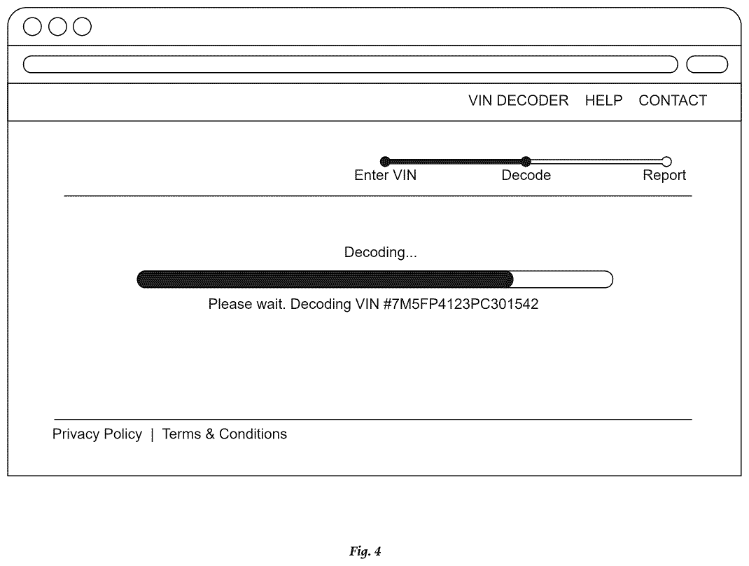

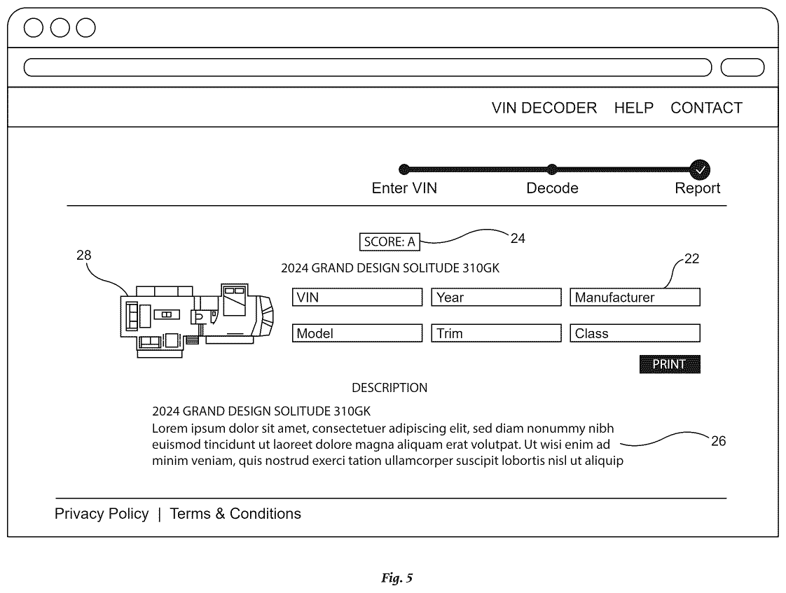

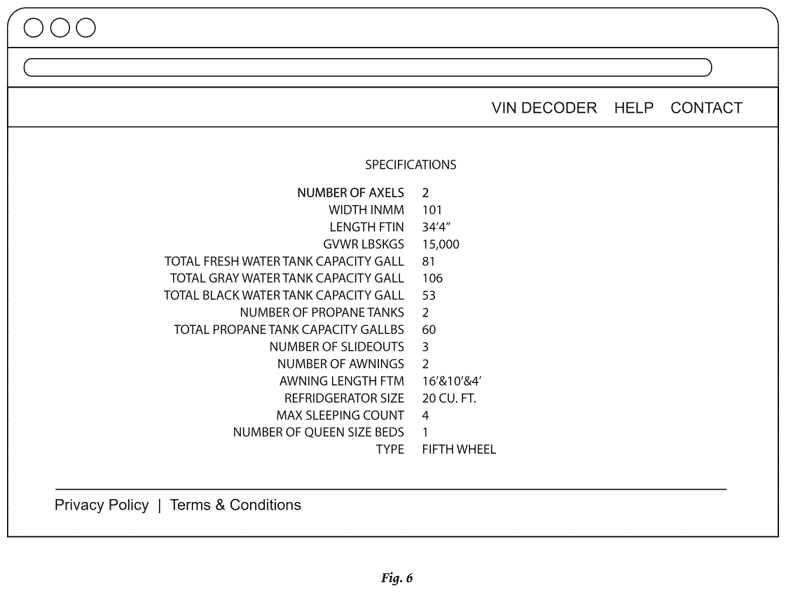

In one or more embodiments, the VIN RV system may be configured and/or programmed to provide a web application or internet application that serves as a platform for RV owners to decode their VINs, as depicted in screenshots provided in FIGS. 3-6. A search bar 20 may be presented via the web application (e.g., on the web page), as depicted in FIG. 3, allowing for easy data retrieval 22 and reliability score 24 retrieval associated with the VIN in the database or databases, as depicted in FIG. 5. Other specifications may also be provided, as depicted in FIG. 6. In instances where a VIN is inaccurately decoded, the web application may present users with the option to input correct details to further aid in refining and improving the database. This feature allows the VIN RV system and users to collaborate to maintain and enhance data accuracy and reliability.

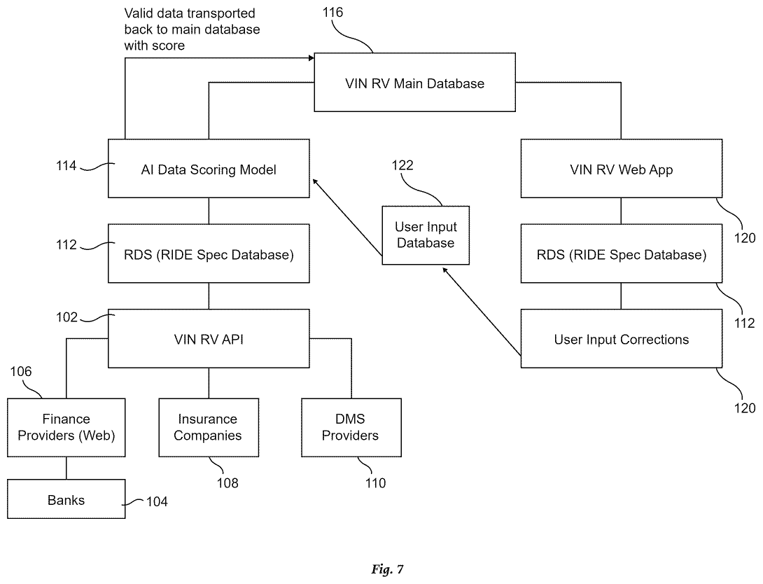

The flow chart in FIG. 7 represents a dynamic data flow within the VIN RV system. In this example embodiment, the processor (e.g., via at least one API 102) is communicably coupled with one or more external processors, servers, or the like. For example, the processor may be communicably coupled with the systems of enterprise users such as banks 104 and/or their finance providers 106, insurance companies 108, or data management service (DMS) providers 110. In response to one or more of these enterprise users initiating a request to the API or processor using a VIN as input, the processor or the API is configured to trigger a database lookup (e.g., via the RDS 112 or other databases) to extract relevant data linked to the entered VIN. Following this, the retrieved data, accompanied by the VIN, can be automatically processed by an AI scoring model 114. This scoring model 114 can evaluate the data and assign a reliability score indicating perceived accuracy of the data as per VIN RV standards. Subsequently, the response to the initial request is formulated, encompassing both the retrieved data and the computed reliability score. This retrieved data and computed score can be provided to the enterprise users and/or a main database 116 configured to store both the RV data and the computed reliability score for future retrieval.

The retrieved RV data and computed score associated with the VIN can also be provided to one or more users or the enterprise users via a front-end web application 118 or web page. Via the web application 118 or web page, RV owners, enthusiasts, and the like can also retrieve data from the RDS 112 and/or the main database 116 for their own data needs. In cases where a user-provided VIN does not have existing records in the main database 116, the web application 118 may be configured to engage the user by seeking additional details concerning the VIN, such as the manufacturer, model, and trim. This freshly acquired data (e.g., user input corrections 120 or updates) can be temporarily housed in a user input database 122. For example, the updates can be updates to any of the data associated with the VIN in the RDS 112 or the main database 116 or can be updates to the VIN itself. In some embodiments, the updates can be updates to the valuation of the RV associated with the VIN.

Then, the updates or the user-provided data can likewise be fed into the AI scoring model. Upon validation (e.g., a reliability score above a given threshold), this user-provided data, now equipped with its own reliability score, can be automatically integrated into the main database 116 via the processor and/or web application. After verification and integration into the main database 116, the processor and/or web application can add the relevant RV unit specifications and provide an outcome to the user. In one or more embodiments, the updates fed into the AI-scoring model can be processed by or otherwise used to train the AI scoring model to improve the scoring of future VIN inputs or associated data.

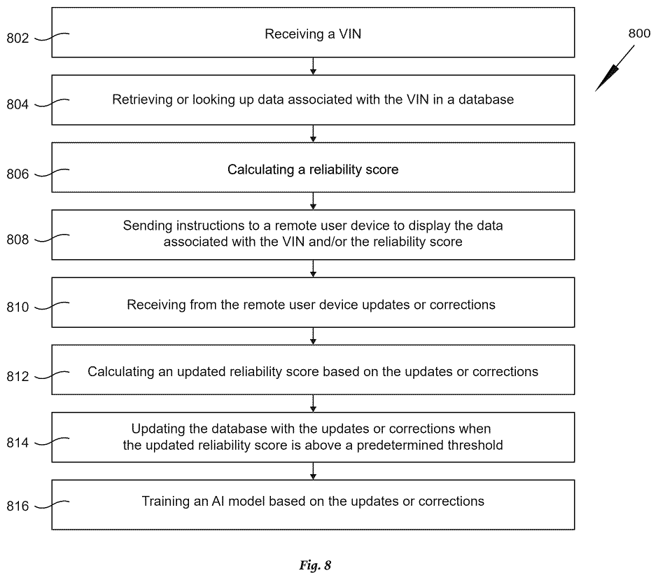

The flow chart of FIG. 8 depicts a method 800 for storing, retrieving, updating, and/or scoring reliability of data associated with RVs or other such vehicles in more detail. In some embodiments, various steps may be omitted, or steps may occur out of the order depicted in FIG. 8 without departing from the scope of the technology as described herein. For example, two blocks shown in succession in FIG. 8 may in fact be executed substantially concurrently, or blocks may sometimes be executed in the reverse order depending upon the functionality involved.

The method may include receiving a VIN, as depicted in block 802. This may include, for example, receiving a VIN from a remote computing device as scanned or manually input into a search bar of a Web app, for example. The method may further include retrieving or looking up data associated with the VIN in a database, as depicted in block 804, and calculating a reliability score, as depicted in block 806. The reliability score, as described above, may be based on the VIN (and/or the data associated with the VIN) based on a set of standards used for the VIN for RVs and/or one or more predetermined rules. For example, the set of standards may include that certain characters are excluded from VINs for RVs or other specific types of vehicles. Thus, the inclusion of those excluded characters may lower the reliability score. So the reliability score may be based on the quantity of characters in the VIN and/or the use of excluded characters (e.g., the reliability score is decreased by a predetermined amount if excluded characters are present in the VIN). In some embodiments, the step of calculating the reliability score is performed by an AI model.

The method 800 can further include sending instructions to a remote user device to display the data associated with the VIN and/or the reliability score, as depicted in block 808. For example, any of the information disclosed in FIGS. 5-6 or described herein may be pulled up using the VIN number or other such RV-identifying information. Specifically, the data associated with the VIN can include one or two or more of any of the following: manufacturer, year, RV make, RV model, trim, valuation, weight, dimensions, axles, capacity, standard features, floorplan images, stock photos of the RV model, specifications of the RV model, and AI-generated summaries of the specifications of the RV model. In some embodiments, the sending of the instructions to the remote user device can comprise sending the instructions via an API or a web application, as described above. In some embodiments, the instructions to the remote user device can additionally or alternatively include instructions to the remote user device to output a warning in response to excluded characters being present in the VIN. For example, the warning can be a visual and/or audio response indicating that the VIN number is not valid or is otherwise problematic and an opportunity may be provided for a user to input corrected information, as described below.

In one or more embodiments, the method 800 can also comprise receiving from the remote user device updates or corrections to the data associated with the VIN and/or updates to the VIN itself, as depicted in block 810. Furthermore, in one or more embodiments, the method 800 can include a step of calculating an updated reliability score based on the updates or corrections, as depicted in block 812, and/or updating the database with the updates or corrections when the updated reliability score is above a predetermined threshold, as depicted in block 814. Furthermore, in one or more embodiments, the method 800 can comprise training an AI model based on the updates or corrections, as depicted in block 816.

Advantageously, the VIN RV system applies advanced AI technology to ascertain data accuracy. Through complex algorithms trained on large datasets, the AI generates the reliability score, reflecting the confidence level in the data's precision, offering complete transparency and fostering trust among users. Moreover, the VIN RV system may be configured for ensuring data security and privacy through the implementing a variety of measures to safeguard user data.

Although the VIN RV system is described herein for use with RVs and RV data, note that alternative systems can be used for storing, retrieving, correcting, and/or scoring reliability of VINs and other associated data for other types of vehicles or products without departing from the scope of the technology described herein. For example, such systems can include VIN numbers and associated vehicle data for cars, trucks, vans, motorcycles, boats, planes, or other vehicles known in the art, along with various schematics and vehicle data, valuations, pictures, or the like.

In some embodiments, the VIN RV system may cover a large range of RV models and trims and may enable precise and timely RV valuations, along with towing guides to assist consumers in their shopping process. The VIN RV system and associated software may advantageously provide transparency, efficiency, and accuracy within the RV industry's VIN decoding field, promoting well-informed decision-making in the RV industry.

The VIN RV system described herein is engineered and configured to facilitate a seamless and efficient experience in the RV industry for consumers, indirect lenders, manufacturers, insurance companies, web platforms and other stakeholders. Below are some example scenarios demonstrating how the VIN RV system can be incorporated into various processes and industries.

In one example embodiment for RV loan processing, a bank (e.g., a prominent national bank that offers loans for RV purchases) often encounters challenges such as user input errors, unreliable information, and inconsistencies in RV specifications. These issues generally slow down the loan approval process and create a cumbersome environment for consumers and indirect lenders. Using the VIN RV system, the bank can integrate the VIN RV system's API into their loan application and approval workflow to streamline the process. This would mean users and lenders only need to input the RV's VIN to automatically populate the loan application with accurate vehicle specifications, thereby reducing the chances of user error and facilitating smoother communication between all parties involved. By adopting the VIN RV system's API, the loan application and approval process at the bank becomes more efficient and user-friendly allowing loan officers to process a higher volume of applications in less time, enhancing business productivity and fostering a better environment for both consumers and indirect lenders.

In an exemplary commercial inventory finance auditing situation, financial institutions and lenders involved in such audits often combat inaccurate audits due to misinformation and discrepancies in RV data. This not only complicates the audit process but also increases the risk of financial inconsistencies and disputes. With the integration of the VIN RV system and/or the API thereof, these institutions can significantly simplify the auditing process. The VIN RV system allows for real-time access to accurate and verified data about each RV in the inventory, facilitated through a straightforward VIN decoding system. This ensures that every audit is based on reliable data and minimizes the potential for errors. Implementing the VIN RV system and/or the API thereof in the auditing process can revolutionize commercial inventory finance auditing by assuring more precise and timely audits that foster transparency and trust between financial institutions and stakeholders, paving the way for a more organized and efficient auditing system in the RV industry.

In an example inventory tracking/DMS environment, the VIN RV system can also be useful. For example, if an RV dealer utilizing a DMS provider continually acquires and sells inventory that may encompass over 1000 units with data that needs to be meticulously recorded in their DMS system for both internal tracking and online advertising, existing processes involve manually entering as many as 100 different specifications for each unit, which is not only time-consuming but also leaves room for human error. Moreover, dealership personnel find themselves tied up with this tedious task rather than focusing on boosting sales. However, if this RV dealer streamlines their process by integrating the VIN RV system (e.g., via the API or web application) into their inventory management system, they can bypass the cumbersome task of manually keying in numerous specifications. Through the integration with the VIN RV system (e.g., via the API or web application), detailed specifications can be auto-populated using the RV's VIN to significantly reduce the risk of errors and save time. The inclusion of the VIN RV system (e.g., via the API or web application) in the inventory management processes transforms the RV dealer's workflow, making it faster and more efficient. This automation not only expedites the process from inventory acquisition to sales but also potentially amplifies sales of RVs, services, and parts, therefore fostering a more agile and profitable business environment.

In an exemplary insurance situation, an insurance company finds the task of accurately assessing risks and generating quotes for RV insurance to be a considerable challenge. The conventional process, which involves collecting detailed and accurate information about each RV, is not only burdensome but also prone to errors, ultimately delaying quote generation and possibly impacting the precision of risk assessments. To overcome this challenge, the insurance company integrates the VIN RV system (e.g., via the API or web application) into their existing system. Now, when clients seek a quote, they simply have to provide the VIN of their RV. The VIN RV system (e.g., via the API or web application) then automatically populates the necessary fields with detailed and precise information regarding the RV in question to streamline the data collection process. Furthermore, the AI-generated reliability score accompanying the data provides the insurance company with an additional layer of confidence regarding the data's reliability and helps to prevent potential errors in risk assessment. The integration of the VIN RV system (e.g., via the API or web application) facilitates a smoother, faster, and more accurate quote generation process for the insurance company. Customers benefit from quicker and more precise quotes, which enhances their overall satisfaction with the service. Additionally, the reliability score provided by the AI minimizes the likelihood of errors in risk assessments and can potentially lead to more profitable and efficient operations for the insurance company.

For an exemplary RV manufacturer (e.g., a leading entity in the RV manufacturing sector), who is a conglomerate of various brands and oversees a diverse range of RV makes and models that span several decades, the VIN RV system (e.g., via the API or web application) can also be useful. In a situation where the RV manufacturer's vast portfolio has inadvertently given rise to data inconsistency and inaccuracies over time, made worse by multiple acquisitions and database consolidations, there can be a lack of reliable and cohesive data on RV specifications, which varies significantly across different periods and databases. Addressing this critical concern, the VIN RV system (e.g., via the API or web application) can be used as a proficient central repository specialized in aggregating accurate RV specification data. This guarantees precise, up-to-date, and easily accessible RV specification data across the entire industry vertical, thus acting as a beacon of reliability in the industry's informational infrastructure. Incorporating the VIN RV system (e.g., via the API or web application) facilitates a streamlined process where the RV manufacturer can effortlessly upload both current and historical RV specifications, including floor plan images 28 and stock photos, ensuring that the products are depicted accurately but also mitigating potential legal issues arising from consumers relying on inaccurate data for determining aspects such as towing capacities, driving specifications, storage dimensions, and other critical product details. Thus, using the VIN RV system (e.g., via the API or web application), the RV manufacturer can help the consumers make informed decisions based on accurate and reliable information while fostering trust and superior satisfaction.

In another example embodiment, a middleware provider facilitates crucial financial transactions between banks and RV dealerships. This role involves collecting comprehensive buyer and unit information and conveying it to banks to establish loan conditions, a process that is currently inefficient and protracted. Recognizing the need to refine the data collection and transmission process, the middleware provider can integrate the VIN RV system (e.g., via the API or web application) into their existing infrastructure. This move not only enhances the credibility of the unit information they collect but also enables them to expedite the process of conveying accurate loan conditions to prospective buyers, thereby optimizing their operations. By incorporating the VIN RV system (e.g., via the API or web application) into their system, the middleware provider can swiftly provide potential buyers with loan conditions, enhancing customer satisfaction and streamlining processes. In this hypothetical, this strategy yields positive outcomes, including an uptick in revenue and a broader business reach, as the middleware provider can now approve more loans rapidly due to the availability of precise data, setting the stage for a more efficient, profitable, and satisfying business experience for all involved parties.

In yet another exemplary scenario, a leading web platform provider that serves RV dealerships is tasked with constructing dealer websites, steering digital marketing initiatives, and facilitating seamless integrations with dealership DMS platforms. The existing method of manual entry for key elements such as descriptions and specifications is not only unmanageable and prone to errors but also doesn't align with the competitive dynamics of the industry. Through the adoption of the VIN RV system (e.g., via the API or web application), the web platform provider can dramatically streamline their operations and revolutionize their approach to search engine coverage and performance, thus eradicating the laborious process of manual data input and allowing for the automatic inclusion of comprehensive RV specifications, floor plans, and a repository of stock photos. This technological advantage positions the web platform provider distinctly ahead of other web platform providers providing them with a competitive edge and reducing their margin of error. By deploying the AI-generated, keyword-rich Summary Unit Description 26 of the VIN RV system, search listings can achieve superior search engine optimization improving both visibility and credibility with consumers, ultimately driving greater success. Through the adoption of the VIN RV system (e.g., via the API or web application), the web platform provider in this hypothetical carves out a substantial competitive edge in the marketplace. The elimination of manual data entry provides for more accurate and comprehensive RV listings that instill a higher degree of confidence in potential customers perusing the dealership websites. Furthermore, this data-rich approach enhances the efficacy of digital marketing efforts and promotes a robust online presence, particularly in organic search results. Ultimately, the alliance between the VIN RV system (e.g., via the API or web application) and the web platform provider catalyzes heightened customer satisfaction and dealer website online visibility and reputation, positioning this hypothetical web platform provider as a frontrunner in the sector.

Throughout this specification, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current invention can include a variety of combinations and/or integrations of the embodiments described herein.

Although the present application sets forth a detailed description of numerous different embodiments, it should be understood that the legal scope of the description is defined by the words of the claims set forth at the end of this patent and equivalents. The detailed description is to be construed as exemplary only and does not describe every possible embodiment since describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as the processor or processing element, may be implemented as special purpose or as general purpose. For example, the processing element may comprise dedicated circuitry or logic that is permanently configured, such as an application-specific integrated circuit (ASIC), or indefinitely configured, such as an FPGA, to perform certain operations. The processing element may also comprise programmable logic or circuitry (e.g., as encompassed within a general-purpose processor or other programmable processor) that is temporarily configured by software to perform certain operations. It will be appreciated that the decision to implement the processing element as special purpose, in dedicated and permanently configured circuitry, or as general purpose (e.g., configured by software) may be driven by cost and time considerations.

Accordingly, the term “processing element” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processing element is temporarily configured (e.g., programmed), each of the processing elements need not be configured or instantiated at any one instance in time. For example, where the processing element comprises a general-purpose processor configured using software, the general-purpose processor may be configured as respective different processing elements at different times. Software may accordingly configure the processing element to constitute a particular hardware configuration at one instance of time and to constitute a different hardware configuration at a different instance of time.

Computer hardware components, such as communication elements, memory elements, processing elements, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at different times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processing elements that are temporarily configured (e.g., by software) or permanently configured to perform the relevant operations. Whether temporarily or permanently configured, such processing elements may constitute processing element-implemented modules that operate to perform one or more operations or functions. The modules referred to herein may, in some example embodiments, comprise processing element-implemented modules.

Similarly, the methods or routines described herein may be at least partially processing element-implemented. For example, at least some of the operations of a method may be performed by one or more processing elements or processing element-implemented hardware modules. The performance of certain of the operations may be distributed among the one or more processing elements, not only residing within a single machine, but deployed across a number of machines. In some example embodiments, the processing elements may be located in a single location (e.g., within a home environment, an office environment or as a server farm), while in other embodiments the processing elements may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processing element and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

The patent claims at the end of this patent application are not intended to be construed under 35 U.S.C. § 112 (f) unless traditional means-plus-function language is expressly recited, such as “means for” or “step for” language being explicitly recited in the claim(s).

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A vehicle identification number (VIN) system comprising:
one or more memory devices comprising a database; and
one or more processors communicably coupled with the one or more memory devices and configured for:
receiving a VIN,
retrieving data associated with the VIN in the database,
calculating a reliability score based on at least one of the VIN and the data associated with the VIN based on a set of standards used for the VIN for a particular type of vehicle or one or more predetermined rules, and
sending instructions to a remote user device to display the data associated with the VIN and the reliability score.

2. The VIN system of claim 1, wherein the one or more processors are further configured for receiving from the remote user device updates or corrections to the data associated with the VIN or updates to the VIN itself.

3. The VIN system of claim 2, wherein the one or more processors are further configured for calculating an updated reliability score based on the updates or corrections and updating the database with the updates or corrections when the updated reliability score is above a predetermined threshold.

4. The VIN system of claim 2, wherein the one or more processors are further configured for training an artificial intelligence (AI) model based on the updates or corrections, wherein the calculating of the reliability score is performed by the AI model.

5. The VIN system of claim 1, wherein the sending of the instructions to the remote user device comprises sending the instructions via an application programming interface (API) or a web application.

6. The VIN system of claim 1, wherein the reliability score is based on quantity of characters in the VIN or the use of excluded characters.

7. The VIN system of claim 6, wherein the reliability score is decreased by a predetermined amount if excluded characters are present in the VIN.

8. The VIN system of claim 1, wherein the one or more processors are further configured for sending instructions to the remote user device to output a warning when excluded characters are present in the VIN.

9. The VIN system of claim 1, wherein the data associated with the VIN includes a plurality of two or more of the following: manufacturer, year, make, model, trim, valuation, weight, dimensions, axles, capacity, standard features, floorplan images, stock photos of the vehicle, specifications of the vehicle, and AI-generated summaries of the specifications of the vehicle.

10. A computer-implemented method for storing, retrieving, updating, and scoring reliability of data associated with recreational vehicles (RV), the computer-implemented method comprising:
receiving a vehicle identification number (VIN),
looking up data associated with the VIN in a database,
calculating a reliability score based on at least one of the VIN and the data associated with the VIN based on a set of standards used for the VIN for RVs or one or more predetermined rules, and
sending instructions to a remote user device to display the data associated with the VIN and the reliability score.

11. The computer-implemented method of claim 10, further comprising receiving from the remote user device updates or corrections to the data associated with the VIN or updates to the VIN itself.

12. The computer-implemented method of claim 11, further comprising calculating an updated reliability score based on the updates or corrections and updating the database with the updates or corrections when the updated reliability score is above a predetermined threshold.

13. The computer-implemented method of claim 11, further comprising training an artificial intelligence (AI) model based on the updates or corrections, wherein the calculating of the reliability score is performed by the AI model.

14. The computer-implemented method of claim 10, wherein the sending of the instructions to the remote user device comprises sending the instructions via an application programming interface (API) or a web application.

15. The computer-implemented method of claim 10, wherein the reliability score is based on quantity of characters in the VIN or the use of excluded characters.

16. The computer-implemented method of claim 15, wherein the reliability score is decreased by a predetermined amount if excluded characters are present in the VIN.

17. The computer-implemented method of claim 10, further comprising sending, in response to excluded characters being present in the VIN, instructions to the remote user device to output a warning.

18. The computer-implemented method of claim 10, wherein the data associated with the VIN includes a plurality of two or more of the following: manufacturer, year, RV make, RV model, trim, valuation, weight, dimensions, axles, capacity, standard features, floorplan images, stock photos of the RV model, specifications of the RV model, and AI-generated summaries of the specifications of the RV model.

19. A non-transitory computer-readable medium storing instructions that, when executed by one or more processors, cause the one or more processors to perform operations comprising:
receiving a vehicle identification number (VIN) for a recreational vehicle (RV) from a remote user device;
retrieving data associated with the VIN in a database;
calculating a reliability score based on at least one of the VIN and the data associated with the VIN based on a set of standards used for VINs;
sending instructions to the remote user device to display the data associated with the VIN and the reliability score;
receiving from the remote user device updates or corrections to the data associated with the VIN or updates to the VIN itself; and
storing the updates or corrections in the database.

20. The non-transitory computer-readable medium of claim 19, further comprising instructions that, when executed by the one or more processors, perform the following operations: calculating an updated reliability score based on the updates or corrections and updating the database with the updates or corrections when the updated reliability score is above a predetermined threshold.
